(19) United States
(12) Patent Application Publication
(10) Pub. No.: US 2005/0073959 A1
(43) Pub. Date: Apr. 7, 2005

(54) Process and device for configurable management of the persistency of data in the equipment of a communication network

(75) Inventors: Patrick Bergeot, Antony (FR); Bertrand Lapraye, Gif Sur Yvette (FR); Pascal Villeret, Clamart (FR); Michel Chevanne, Clamart (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/901,190

(22) Filed: Jul. 29, 2004

(30) Foreign Application Priority Data
Aug. 1, 2003 (FR) 03 09 511

(51) Int. Cl. H04L 12/26

(52) U.S. Cl. 370/241

(57) ABSTRACT

A device (D) is dedicated to the management of data persistency within an equipment management system (EMS) of a communication network that includes a large variety of network equipment (NE-i), where the equipment management system (EMS) is coupled to the equipment and to a network management system (NMS), and that includes a management information tree (MIT), coupled to the device (D), representing links between equipment (NE-i), and that includes primary data. This management device (D) includes configurable conversion resources (MTR) that are responsible for converting at least some of the primary data of the management information tree (MIT) into persistent data in accordance with persistency models which are each associated with different storage media (FP, BD), with a view to their storage in the storage medium which is associated with the persistency model that has been used for their conversion.

The invention concerns the management of equipment (or elements) in a communication network using a network management system (NMS).

“Network equipment” refers here to any type of hardware, such as servers, terminals, switches, routers or concentrators, for example, capable of exchanging data, in particular management data with the network management system (NMS) of the network to which it belongs, in accordance with a network management protocol. The network management protocol can be the SNMP protocol (the RFC 2571-2580 Simple Network Management Protocol), for example, used in particular in ADSL type networks, the TL1 protocol used in particular in SONET type networks, the Q3 protocol used in particular in SDH type networks, or indeed the CLI and CORBA protocols.

In addition, “network management system” here refers to a network operating system that enables its manager (or supervisor) to manage the equipment (or elements) of the network of which it is composed, and which are incapable of doing so themselves. Such a network management system (NMS) includes, or is coupled to, tools that implement functions and services, also called OAM&P (Operations, Administration, Maintenance and Provisioning). Among these tools, one can in particular mention the equipment management system (EMS), which is responsible for providing the dialogue interface between the network equipment and the network management system (NMS).

These equipment management systems (EMS) generate (primary) information data relating to the different network equipment elements, which, in some cases, must sometimes be stored in a persistent manner. Depending on the equipment management system (EMS) configuration, this persistent storage (also called durable storage) takes place either in flat files or in a database, such as Oracle or Informix, which is generally the same as that used by the network management system (NMS).

Because of the constantly increasing heterogeneity of the network equipment and of the associated management protocols, the (primary) equipment data are heterogeneous, and correspondent to different persistency (or durability) models suitable for different storage media.

Since the persistency mechanism of the equipment management systems (EMS) is generally hard coded so as to be suitable for a single type of storage medium, it is therefore not, very suitable for the current situation.

The purpose of the invention is therefore to remedy this drawback.

To this end, it proposes a device for the management of data persistency in an equipment management system (EMS), in a communication network that includes a large amount of network equipment, where the said equipment management system (EMS) is coupled to the equipment and to a network management system (NMS), and where it includes a management information tree (MIT), coupled to the device of the invention, representing links between equipment, and consisting of primary data.

This management device is characterized by the fact that it includes configurable conversion resources that are responsible for converting at least some of the primary data of the management information tree into persistent data in accordance with persistency models, each associated with different storage media (of the flat file and/or database type, for example, possibly of the relational type), with a view to their storage in the storage medium associated with the storage model that has been used for their conversion.

It is important to note that it is possible to use either several persistency models which are independent of each other, or several persistency models that are constituents of the parts of a single “meta persistency model”.

Preferentially, the conversion resources are responsible for determining firstly the association of the primary data with different selected persistency sets, associated with the different persistency models, and then for converting these primary data into persistent data in accordance with the persistency model associated with the persistency set to which they belong.

The device in accordance with the invention can include other characteristics, which can be taken separately or together, and in particular:
it can be controlled by equipment description resources (MEM) of the equipment management system (EMS), including descriptors for example (computer modules containing all the data necessary for the management, by the network management system (NMS), of at least one equipment element),
conversion resources arranged so as to convert the primary data into persistent data by generating data tables in the format of the corresponding storage medium,
conversion resources which are responsible, once they have performed a conversion of primary data into persistent data, for generating a storage interface, of the JDBC type for example, suitable for storage of the persistent data in the corresponding storage medium,
primary data defining objects, and persistency sets defining object classes,
conversion resources composed of at least one configuration file, of the XML type for example, and of at least one program code file, in the Java language for example.

The invention also proposes an equipment management system (EMS) for a communication network that includes a large variety of network equipment, and intended to be coupled to this equipment and to a network management system (NMS), and that includes a management information tree (MIT) coupled to a management device of the type presented above.

The invention also proposes a management server, a network management system (NMS), and a network equipment element, each equipped with an equipment management system (EMS) of the type presented above.

The invention also concerns a process for the management of data persistency in a communication network that includes a large variety of network equipment elements coupled to an equipment management system (EMS), which itself is coupled to a network management system (NMS) and includes a management information tree (MIT).

This process is characterized by the fact that it consists of converting at least some of the primary data into persistent data in accordance with persistency models, each associated with different storage media (such as flat files and a database, possibly of the relational type), with a view to their storage in the storage medium associated with the persistency model that has been used for their conversion.

Preferentially, the association of the primary data with selected persistency sets associated with the different persistency models is determined, and then these primary data are converted into persistent data in accordance with the persistency model associated with the persistency set to which they belong.

Again preferentially, the primary data are converted into persistent data by generating data tables in the format of the corresponding storage medium.

In addition, after performing a conversion of primary data into persistent data, it is particularly advantageous to generate a storage interface, of the JDBC type for example, suitable for the storage of persistent data in the corresponding storage medium.

In particular, the invention can be implemented in all network technologies, which must be managed, and in particular in transmission networks (of the WDM, SONET, and SDH type for example), data networks (of the Internet-IP or ATM type for example) or speech networks (of the conventional, mobile or NGN type for example).

Other characteristics and advantages of the invention will be seen on studying the following detailed description and the appended figures, in which:

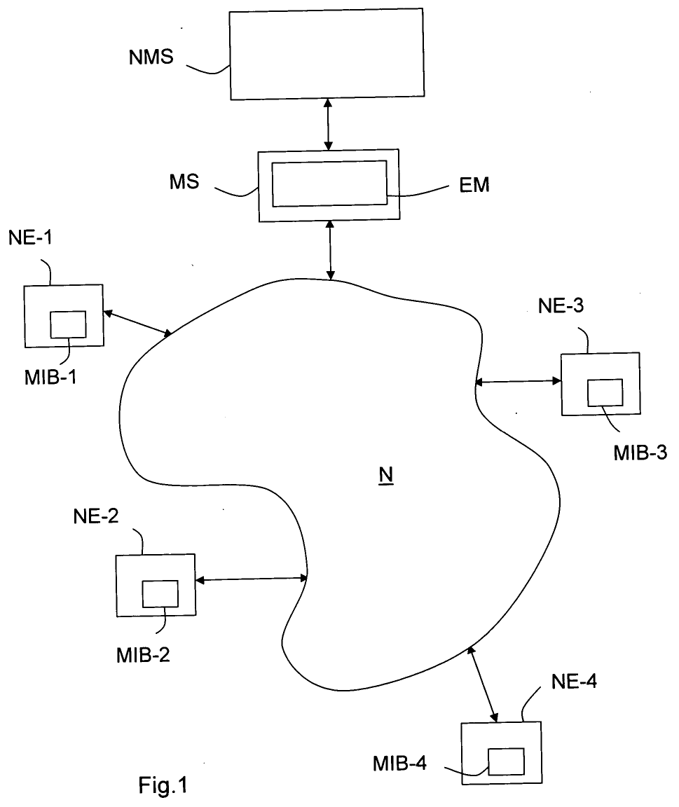

FIG. 1 illustrates, in schematic fashion, an example of a communication network equipped with an equipment management system (EMS) in accordance with the invention, installed in a management server, and

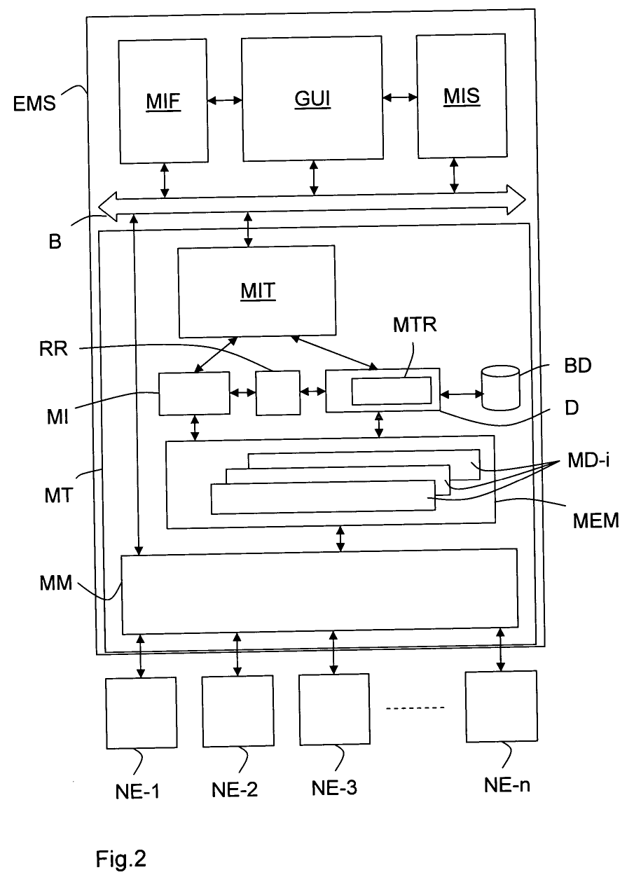

FIG. 2 illustrates, in schematic fashion, an example of implementation of a management device in accordance with the invention, installed in a processing module (MT) of an equipment management system (EMS).

The appended figures can not only serve to complete the invention, but also contribute to its specification, where appropriate.

The purpose of the invention is to allow management of durable (primary) data storage in network equipment within the equipment management system (EMS) of a communication network.

In what follows, we consider, as an illustrative example, that the communication network is at least partially of the Internet Protocol (IP) type. But the invention also applies to other types of network, such as, for example, transmission networks of the WDM, SONET or SDH type, to data networks of the ATM type, or to speech networks of the conventional, mobile or NGN type.

As shown in FIG. 1, a communication network (N) is, in a very schematic manner, composed of a large variety of network equipment (or elements (NE-I) (where, as an example, i=1 to 4), linked to each other by communication resources and connected, at least in the case of some of them, to a Network Management System (NMS) via a management server (MS). As indicated in the introductory part, the network management system (NMS) is intended to enable the manager (or supervisor) of the network to remotely manage and monitor the equipment (NE-i) to which it is coupled.

Here “network equipment” (NE-I) refers to hardware that is capable of exchanging management data with the management server (MS), in accordance with a selected management protocol, such as, for example, the SNMP protocol (the RFC 2571-2580 Simple Network Management Protocol), or the TL1, CORBA, CLI or Q3 protocols. It concerns, for example, edge or core servers, terminals, switches, routers or concentrators.

Here, the management server (MS) is equipped with an equipment management system (EMS) which is responsible for providing the dialogue interface between the network equipment and the network management system (NMS), and for generating information data, known as primary data, relating to the equipment in the network (NE-i).

As shown in FIG. 2, an equipment management system (EMS) includes a processing module (MT) coupled, via a bus (B), preferably of the CORBA type, to a graphical interface module of the Graphical User Interface (GUI) type for example, and to a functional interface module (MIF) and a system interface module (MIS). The system interface module (MIS) and the functional interface module (MIF) are additionally coupled to the GUI as well as to the network management system (NMS).

The graphical user interface (GUI), and/or the functional interface module (MIF) and/or the system interface module (MIS) are not necessarily located in the same place as the rest of the equipment management system (EMS). The processing module (MT) (also known by the acronym EMA) can in fact be installed in a management server (MS) or in network equipment element (NE-i), while the graphical user interface (GUI) can be installed in the network management system (NMS).

The processing module (MT) includes a mediation module (MM), which is responsible for executing the dialogue between the interfaces of the network (and in particular those of the equipment) and coupled firstly to a management information tree (MIT) and secondly to a memory (MEM) in which descriptors (MD-i) are stored, each associated with at least one equipment element (NE-i), such as an integrated-circuit card or a connection interface for example, and in particular designating the exchange protocol associated with the said element.

A descriptor is a computer module which contains all of the data necessary for the management by the network management system (NMS) of at least one equipment element (NE-i). Each dedicated descriptor (MD-i) is preferentially composed of program code files, preferably in the Java language and allowing discussion with an equipment interface, of a file containing data designating a type of equipment, of a file containing data which describe a specification for a management information base (MIB), stored in the network management system (NMS) or in the processing module (MT) and associated with the management information base -MIB-i) of the equipment (NE-i) of the type considered, and of configuration files, of the XML type for example, which contain information that can be used to manage a type of equipment in the network.

The mediation module (MM) is mainly responsible for the management of alarms and events, and allows the network management system (NMS) to administer the equipment (NE-i) with the assistance of the functional interface module (MIF) and the system interface module (MIS). The management of alarms and events allows the network management system (NMS) to retrieve the information data representing the operational state of the equipment, and in particular alarms and reports on events that have occurred in the equipment (NE-i), in order to provide for its management (by setting off suitable actions for example).

Preferentially, the processing module (MT), and in particular its mediation module (MM), is implemented in the form of software or computer modules, meaning in the form of program code files. More preferentially still, these program code files are in the Java language. And even more preferentially, the program codes comply with the C Virtual Machine (CVM) recommendations (where the letter C designates the word “compact”, the word “connected”, the expression “consumer-oriented”, and the C language), in order to allow the device to be installed in an element of network equipment, including in a portable computer.

But of course the processing module (MT) could also be implemented in the form of a combination of hardware (electronic) and software modules.

The functional interface module (MIF) is more particularly responsible for the exchange of information both with the network management system (NMS) and with the network equipment (NE-i), via the processing module (MT), and in particular its mediation module (MM). In particular, given the description data contained in the descriptors (MD-i), it is responsible for retrieving, via the processing module (MT), information coming from the equipment (NE-i) of the network, such as alarms and events for example, in order to communicate this to the network management system (NMS) so that it can administer and manage the said equipment.

Since some information can be retrieved in an automatic manner, the processing module (MT) includes a polling (interrogation) module (MI), coupled to the management information tree (MIT) and to the memory (MEM), and responsible for interrogating, preferably in a cyclical manner, (passive) equipment which does not spontaneously supply the information representing its operational state. This polling module (MI) can also be coupled to a memory of the registration repository (RR) type. Such a module (MI) is particularly useful in access networks that include many equipment elements, and in passive networks.

The system interface module (MIS) is particularly responsible for organization of the dialogue between the network management system (NMS) and the equipment management system (EMS).

The system interface module (MIS) includes a persistency (durable storage) interface, responsible in particular for managing the storage of management information data (or profiles), known here as primary data, extracted from the management information table (MIT) and concerning equipment (NE-i) associated with certain priority levels or particular contexts specified by persistency policies. These primary data are preferably store in storage media either within the equipment management system (EMS) or external to it. In the illustrated example, the storage medium comes in the form of a database (BD), of the relational type (RDBMS) for example. But, it could also be several different databases or flat files (FP).

In accordance with the invention, the storage of these primary data is accomplished with the aid of a durable-storage management device (D), also called an “MIT persistency tool”.

More precisely, the device according to the invention is intended to allow dynamic management of the persistent or durable storage of (primary) equipment data in the network (NE-i).

To this end, it includes a configurable conversion module (MTR), which is responsible for converting, on command, at least some of the primary data contained in the management information tree (MIT) into persistent data in the format of a storage medium.

More precisely, this conversion is effected in accordance with persistency models, each of which is associated with one of the media (FP or BD). It is preferably controlled by the descriptor (MD-i) which has been loaded (or activated) at a given moment by the mediation module (MM) at the command of the network management system (NMS).

In order to successfully perform this conversion, the conversion module (MTR) begins by analyzing the primary data that it receives, in order to determine the persistency model that corresponds to them, and therefore the medium (FP or BD) in which they must be stored.

Preferably, the primary data, which are generally objects (in the computer meaning of the term), can be grouped into sets or object classes, each associated with a persistency model. In practice, it is preferable to provide for only a single persistency model (or meta model) subdivided into parts, each of which are dedicated to one object class, for example, each part coming in the form of a table in the format of the storage medium and in which each column is dedicated to one of the attributes of the corresponding object class. The conversion module (MTR) is therefore configured so as to recognize the set to which the received (primary) data (or objects) belong.

To this end, three cases can be envisaged. In a first case, the primary data (or objects) are accompanied by an identifier representing their association class. The conversion module (MTR) therefore needs only a correspondence table between the class identifiers and the persistency model parts (or persistency models) in order to determine the persistency model part (or persistency model) to be applied to the primary objects received.

In a second case, the primary objects are raw (or lacking any class identifier). The conversion module (MTR) therefore requires, for example, a first correspondence table between the primary objects and the class identifiers, and a second correspondence table between the class identifiers and the persistency model parts (or persistency models), in order to determine the persistency model part (or persistency model) to be applied to the primary objects received. These two tables can be combined into a single table with multiple inputs. In a variant, a single correspondence table can be used between the primary objects and the persistency model parts (or persistency models).

In a third case, one of the descriptors (MD-i) caters for the correspondence (or “mapping”) between the internal persistency model of the conversion module (MTR) and the external model of the storage medium. As a consequence, the conversion module (MTR) automatically knows which persistency model part (or persistency model) it has to apply to the primary objects that it receives.

Once a persistency model part (or a persistency model or indeed a storage medium) has been determined, the conversion module then only has to convert the primary objects into persistent objects in the format of the storage medium (FP or BD) associated with the said persistency model part (or persistency model).

The conversion consists, for example, of generating data tables in the format of the selected storage medium (FP or BD). When the data are objects, the columns of the tables are then filled with the (persistent) attributes of the primary objects to be made persistent.

In the case of a database of the MySQL type for example, the tables are of the SQL type.

In addition, in the case of a relational database, the conversion establishes the link between the object that is to be made persistent, in an absolute manner (meaning in a version known as FDN (Full Distinguished Name), and the key of the relational database.

Moreover, when the conversion module (MTR) has completed its conversion of primary data into persistent data, it is advantageous that it should generate a storage interface that is suitable for storage of the persistent data in the corresponding storage medium.

This storage interface is preferably of the JDBC type. This type of interface is particularly useful to the extent that it provides compatibility with all types of database (BD) and all types of flat file (FP). In other words, by using a JDBC interface, the device according to the invention is rendered independent of the storage medium employed.

The persistent data (or objects) are then transmitted to the selected storage medium (FP or BD) with a view to their storage in accordance with the selected persistency model part (or persistency model).

The conversion module (MTR) is preferably composed of configuration files and of program code files, in the Java language for example.

Each configuration file is advantageously of the XML type. In fact, this programming language is particularly user-friendly and easy to use. In addition, the program code files are advantageously in the Java language, because of the ability of this language to load and unload computer codes dynamically.

The constitution of the conversion module (MTR) is effected in the following way for example. First, one begins by specifying what is intended to be made persistent. To this end, one defines, for example, primary object classes (delivered by the MIT), and one then associates a persistency model part (or a persistency model) with each object class.

One then defines internal functions that are enriched by code (these are called object factories), and intended to construct the different classes defined previously. These functions are then preferably stored in a dedicated part of the memory of the registration repository (RR) type.

One then specifies how one wishes to cause the data (or objects) of each set (or class) to persist. For this purpose, one associates a storage medium (possibly the same) with each persistency model part (or each persistency model). A persistency model is a configuration file, XML for example, which defines rules that allow conversion of the objects of a class into persistent objects in the format of the corresponding storage medium. In other words, it defines a number of data storage tables and the relations between these tables.

Finally, one defines the parameters of each interface (JDBC) which will allow the transfer of the persistent data (or objects), defined in an absolute manner, to the corresponding storage medium.

The invention also proposes a process for the management of data (or object) persistency, for a communication network (N) that includes a large variety of network equipment (NE-i) coupled to an equipment management system (EMS), which itself is coupled to a network management system (NMS) and includes a management information tree (MIT).

In particular, this can be implemented by means of the management device (D) and the equipment management system (EMS) presented above. Since the main and optional functions and sub-functions performed by the stages of this process are more or less identical to those performed by the different resources making up the management device (D) and/or equipment management system (EMS), then the following will be a description only of the stages implementing the main functions of the process according to the invention.

This process consists of converting at least some of the primary data (or objects) into persistent data (or objects) in accordance with persistency models, each of which is associated with different storage media (such as flat files (FP) and a database (BD), possibly of the relational type), with a view to their storage in the storage medium which is associated with the persistency model that has been used for their conversion.

Preferably, the association of the primary data (or objects) with selected persistency sets (or object classes), associated with the different persistency models, is determined, and then these primary data are transformed into persistent data in accordance with the persistency model which is associated with the persistency set to which they belong.

The invention is not limited to the embodiment of the management device of persistency model (D), of the equipment management system (EMS), of the management server (MS) and the persistency model management process described above as an example only, but covers all variants that can be envisaged by the professional designer in the context of the following claims.

This is therefore a description of an equipment management system (EMS) installed in a management server of a network management system (NMS). However, the equipment management system (EMS) could be installed in a network equipment element, or indeed in a terminal that is dedicated to the local management of equipment, also known as a “craft terminal”.

1. A device (D) for the management of data persistency in an equipment management system (EMS) of a communication network (N) that includes a large variety of network equipment (NE-i), where the said equipment management system (EMS) is coupled to the said equipment (NE-i) and to a network management system (NMS), and includes a management information tree (MIT) which is coupled to the said device (D), representing links between the equipment (NE-i), and which includes primary data, characterized in that it includes configurable conversion resources (MTR) which are arranged so as to convert at least some of the said primary data into persistent data in accordance with persistency models, each of which is associated with different storage media (FP, BD), with a view to their storage in the storage medium associated with the persistency model that has been used for their conversion.

2. A device in accordance with claim 1, characterized in that the said conversion resources (MTR) are arranged so as to determine the association of the said primary data with selected persistency sets associated with the different persistency models, and then to convert these primary data into persistent data in accordance with the persistency model associated with the persistency set to which they belong.

3. A device in accordance with claim 1, characterized in that it is suitable to be controlled/monitored by equipment description resources (MEM) of the said equipment management system (EMS).

4. A device in accordance with claim 1, characterized in that the said conversion resources (MTR) are arranged so as to convert the said primary data into persistent data by the generation of data tables in the format of the corresponding storage medium (FP, BD).

5. A device in accordance with claim 1, characterized in that the said conversion resources (MTR) are arranged, after performing a conversion of primary data into persistent data, so as to generate a storage interface that is suitable for the storage of the said persistent data in the corresponding storage medium (FP, BD).

6. A device in accordance with claim 5, characterized in that the said storage interface is of the JDBC type.

7. A device in accordance with claim 1, characterized in that the said conversion resources (MTR) are arranged so as to deliver persistent data that are matched to storage media selected from a group that includes at least flat files (FP) and databases (BD).

8. A device in accordance with claim 7, characterized in that at least one of the databases (BD) is of the relational type.

9. A device in accordance with claim 1, characterized in that the said primary data describes objects, and in that the said persistency sets are object classes.

10. A device in accordance with claim 1, characterized in that the said conversion resources (MTR) include at least one configuration file and at least one program code file.

11. A device in accordance with claim 10, characterized in that each configuration file is of the XML type.

12. A device in accordance with claim 10, characterized in that the said program codes are in the Java language.

13. An equipment management system (EMS) for a communication network (N) that includes a large variety of network equipment (NE-i), and suitable to be coupled to the said equipment (NE-i) and to a network management system (NMS), and that includes a management information tree (MIT) representing links between equipment, and that includes primary data, characterized in that it includes a management device (D) in accordance with one of the preceding claims, coupled to the said management information tree (MIT) and to equipment description resources (MEM).

14. A management server (MS) in a network management system (NMS), characterized in that it includes an equipment management system (EMS) in accordance with claim 13.

15. Network equipment (NE-i), characterized in that it includes an equipment management system (EMS) in accordance with claim 13.

16. A process for the management of data persistency for a communication network (N) that includes a large variety of network equipment (NE-ij), and a network management system (NMS) coupled to an equipment management system (EMS) coupled to the said equipment (NE-i), representing links between equipment, and that includes a management information tree (MIT) that includes primary data, characterized in that it consists of converting at least some of the said primary data into persistent data in accordance with persistency models, each of which is associated with different storage media (FP, BD), with a view to their storage in the storage medium associated with the persistency model that has been used for their conversion.

17. A process in accordance with claim 16, characterized in that the association of the said primary data to selected persistency sets associated with the different persistency models is determined, and then these primary data are converted into persistent data in accordance with the persistency model associated with the persistency set to which they belong.

18. A process in accordance with claim 16, characterized in that the said primary data are converted into persistent data by the generation of data tables in the format of the corresponding storage medium.

19. A process in accordance with claim 16, characterized in that after performing a conversion of primary data into persistent data, a storage interface is generated that is suitable for the storage of the said persistent data in the corresponding storage medium (FP, BD).

20. A process in accordance with claim 19, characterized in that a storage interface of the JDBC type is generated.

21. A process in accordance with claim 16, characterized in that persistent data is delivered which is matched to storage media selected from a group that includes at least flat files (FP) and databases (BD).

22. A process in accordance with claim 21, characterized in that at least one of the databases (BD) is of the relational type.

23. A process in accordance with claim 16, characterized in that the said primary data describes objects, and in that the said persistency sets are object classes.

24. Use of the management device (D), management server (MS), network equipment (NE-i), equipment management system (EMS) and management process in accordance with one of the preceding claims in the network technologies which have to be managed.

25. Use in accordance with claim 24, characterized in that the said network technologies are selected from a group that includes transmission networks, in particular of the WDM, SONET and SDH type, data networks, in particular of the Internet-IP and ATM type, and speech networks, in particular of the conventional, mobile and NGN type.
